(19) United States
(12) Patent Application Publication
(10) Pub. No.: US 2003/0169877 A1
(43) Pub. Date: Sep. 11, 2003

(54) Pipelined engine for encryption/authentication in IPSEC

(76) Inventors: Fang-Cheng Liu, Hsinchu (TW); Tsai-Te Lin, Hsinchu (TW)

Correspondence Address: MARTINE & PENILLA, LLP, 710 LAKEWAY DRIVE, SUITE 170, SUNNYVALE, CA, 94085, US

(21) Appl. No.: 10/199,283

(22) Filed: Jul. 19, 2002

(30) Foreign Application Priority Data
Mar. 5, 2002 (TW) 91104221

(51) Int. Cl. H04K 1/00

(52) U.S. Cl. 380/28

(57) ABSTRACT

The invention provides a device by using a pipelined architecture for enhancing the efficiency and speed of encryption/authentication. To handle all modes defined in RFC2401, 3 DES-HMAC sub-engines are built in the IPSEC engine. Each DES-HMAC sub-engine includes one DES engine and one HMAC engine. By utilizing the pipelined architecture for the combinations of multiple modes, it does not take any waiting time in the encryption and authentication processing. A data block is immediately sent to the next DES_HMAC sub-engine for the next encryption and authentication process right after the previous DES_HMAC sub-engine has outputted the data block.

### BACKGROUND OF THE INVENTION

1. Field of the Invention

The invention relates generally to a pipelined engine for encryption/authentication and, more specifically, for accelerating the encryption/authentication processing in an IPSEC (IP Security/RFC 2401).

2. Description of the Related Art

The primary function of an IPSEC is to encrypt data so that it can only be deciphered and read by the intended receiver of the data packet. However, the IPSEC encryption and decryption processing requires intensive CPU computation. The performances of PCs and servers become poor because their processors are focused on the encryption function instead of the other functions required by users.

In order to improve the processor utilization, porting the encryption function onto an application specific integrated circuit (ASIC) is a normal solution presently.

The architecture of an IPSEC processor in current technology is shown in FIG. 1. The packet processor 11 deals with the partition, adding the header, and updating the security association database (SAD) including keys, security parameter index (SPI), sequence number, and so on. The IPSEC engine 12 receives a plain text packet sent from the packet processor 11 in the transmit (TX) mode. After encryption and authentication, the packet is transmitted to the internet via the network processor 13. In the receive (RX) mode, the network processor 13 receives the packet from the internet. First, the corresponding SAD and the security policy database (SPD) are searched by means of a lookup operation according to the packet including SPI, sequence number, and so on. Then, the found SAD together with the encrypted and authenticated packet is inputted into the IPSEC engine 12. Finally, the output is a plain text packet and is transmitted to the CPU.

As defined in RFC 2401, there are 15 combinations of the security association (SA) mode that the IPSEC implementation must support, wherein the encryption and authentication must be processed more than once by an engine in some modes, such as iterated tunnel mode and adjacency mode. Therefore, a single engine in current technology is required to handle the whole encryption and authentication processes in these modes. Employing this architecture, the engine needs to finish the previous encapsulating security payload (ESP) or authentication header (AH) process of the packet with a first SAD. After the whole packet is done by this step, the engine is re-configured with a new SAD, and then begins to deal with the encrypted or authenticated packet by the second ESP or AH process. After the packet finishes all of the IPSEC processes (encryption and authentication), the next packet is allowed to enter the in_fifo for the encryption or AH process. In other words, the next packet cannot enter the engine unless the previous packet is done.

Two examples will be set forth in detail hereinafter. As shown in FIG. 2A, the tunnel mode is set between a host and a host, as well as between a host and a security gateway. Moreover, the IPSEC engine of FIG. 2B is in the TX status and set in the ESP tunnel+ESP tunnel mode, and FIG. 2C shows the ESP AH adjacency mode which is the only mode needed to feedback in the RX status.

Referring to FIG. 2B, before the upper layer begins transmitting packets in the ESP mode, the engine is initially configured with the matched SAD1, and then a first packet begin the process in the data encryption standard_hashing for message code (DES_HMAC) engine. The encryption and authentication algorithm is based on a fixed block size (64-bit for encryption and 512-bit for authentication). Accordingly, after all blocks of the packet finish the first ESP procedure and become cipher, the ciphered packet is returned to the in_fifo to wait for the second ESP process. Before this step, the SAD2 is inserted and used to re-configure the engine. When the configuration step is done, the ciphered packet enters this engine for the second ESP process with the SAD2. The output is the final result of the whole process.

As shown in FIG. 2C, as the authenticated and encrypted packet enters the in_fifo, the engine is first configured with the matched SAD1, and then a first packet begins the authentication process in the DES_HMAC sub-engine. After all blocks of the first packet finish the first authentication process and an authentication value is calculated, the authenticated packet is returned to the in_fifo if the authentication value is the same as a value in the AH header. Then, the engine is configured with the SAD2 and the authenticated packet enters this engine for the ESP process with the SAD2. The output becomes a plain text and is transmitted to the upper layer.

In other words, as long as the engine is still in the first ESP or AH procedure of the packet, the cipher block data or authenticated block data of the packet must be hold in the out_fifo. And it cannot be passed to the in_fifo for the second ESP process unless all blocks of the packet is done by the DES_HMAC sub-engine with the SAD1. Namely, before the packet finishes all of the steps of the SA mode, a new packet cannot be transmitted and dealt with; therefore, it takes a lot of time to wait for the previous packet and the performance of the chip is degraded.

Although porting the IPSEC from the software to the ASIC does enhance the CPU utilization and the performance of the other tasks, we need to improve the efficiency of encryption and authentication in the IPSEC implementation in order to handle the obvious overhead on the network.

### SUMMARY OF THE INVENTION

Due to the problems mentioned above, an objective of the invention is to provide a pipelined device for finishing all required procedures without wasting time upon processing the encryption/authentication in IPSEC inside packet or between packets.

To achieve the above objective, an aspect of the invention provides a pipelined device for the encryption/authentication processing in an IPSEC, which is set as the transmit (TX) mode and comprises a first FIFO, a first data encryption standard_hashing for message code (DES_HMAC) sub-engine, a second FIFO, a second DES_HMAC sub-engine, a third FIFO, a third DES_HMAC sub-engine, a fourth FIFO and a control line.

When a host is going to transfer the data with the IPSEC, the control line is connected to the second FIFO, the third FIFO and the fourth FIFO, respectively. The software looks up in a Security Policy Database (SPD) and a Security Association Database (SAD) table to determine the matched SAD for data transmission according to the data of the packet descriptor, and then the Security Association (SA) is set. The first DES_HMAC sub-engine, the second DES_HMAC sub-engine and the third DES_{'}HMAC sub-engine are simultaneously configured with the correspondingly matched SAD before packets are transmitted. The software knows the number of the DES_HMAC sub-engine that the SA needs according to the built SA and then uses the number as a control signal. The control signal controls the data flow direction through the control line, wherein the packet processing comprises the following steps:

(1) when the configuration is done and the upper layer starts to transmit a first packet, the first packet is divided into multiple blocks in a packet processor and then a first block enters the first DES_HMAC sub-engine for the first encryption/authentication process through the first FIFO;

(2) two operations are simultaneously performed if the control signal is one-sub-engine mode: while the first block of the packet is outputted from the first DES_HMAC sub-engine into the second FIFO, it directly enters the fourth FIFO without passing the second DES_HMAC sub-engine and then is transferred to the internet; meanwhile, a second block of the packet enters the first the first DES_HMAC sub-engine for the first encryption/authentication process through the first FIFO;

(3) two operations are simultaneously performed if the control signal is not one-sub-engine mode: the first block of the packet directly enters the second DES_HMAC sub-engine for the second encryption/authentication process through the second FIFO without waiting; meanwhile, a second block of the packet enters the first the first DES_HMAC sub-engine for the first encryption/authentication process through the first FIFO;

(4) three operations are simultaneously performed if the control signal is two-sub-engine mode: while the first block of the packet is outputted from the second DES_HMAC sub-engine into the third FIFO, it directly enters the fourth FIFO without passing the third DES_HMAC sub-engine and is then transferred to the internet; while the first encryption/authentication process has been finished, the second block of the packet enters the second DES_HMAC sub-engine for the second encryption/authentication process through the second FIFO without waiting; meanwhile, a third block of the packet enters the first DES_HMAC sub-engine for the first encryption/authentication process through the first FIFO;

(5) three operations are simultaneously performed if the control signal is three-sub-engine mode: the first block of the packet directly enters the third DES_HMAC sub-engine for the third encryption/authentication process through the third FIFO without waiting; while the first encryption/authentication process has been finished, the second block of the packet enters the second DES_HMAC sub-engine for the second encryption/authentication process through the second FIFO without waiting; meanwhile, a third block of the packet enters the first the first DES_HMAC sub-engine for the first encryption/authentication process through the first FIFO;

(6) four operations are simultaneously performed if the control signal is three-sub-engine mode: while the first block of the packet is outputted from the third DES_HMAC sub-engine to the fourth FIFO, it is ready to be transferred to the internet; while the second encryption/authentication process has been finished, the second block of the packet enters the third DES_HMAC sub-engine for the third encryption/authentication process through the third FIFO without waiting; while the first encryption/authentication process has been finished, the third block of the packet enters the second DES_HMAC sub-engine for the second encryption/authentication process through the second FIFO without waiting; meanwhile, a fourth block of the packet enters the first DES_HMAC sub-engine for the first encryption/authentication process through the first FIFO;

(7) Proceeds until all packets have been processed.

Another aspect of the invention provides a pipelined engine for the decryption/authentication in IPSEC, set as the receive (RX) mode, comprising a first FIFO, a first DES_HMAC sub-engine, a second FIFO, a second DES_HMAC sub-engine, a third FIFO, a third DES_HMAC sub-engine, a fourth FIFO and a control line.

When a host is going to transfer the data with the IPSEC, the control line connected to the second FIFO, the third FIFO and the fourth FIFO, respectively. The software looks up in a SPD and a SAD table to determine the matched SAD for data reception according to the packet data (Security Parameter Index, sequence number, . . . etc), and then SA is set. The first DES_HMAC sub-engine and the second DES_HMAC sub-engine are simultaneously configured with the correspondingly matched SAD before packets are received. The software knows the number of the DES_HMAC sub-engine that the SA needs according to the built SA and then uses the number as a control signal. The control signal controls the data flow direction through the control line, wherein the packet processing comprises the following steps:

(1) after the configuration is done, a first packet is received from the internet and then enters the first DES_HMAC sub-engine for the first decryption/authentication process through the first FIFO;

(2) two operations are simultaneously performed if the control signal is one-sub-engine mode: while the first packet is outputted from the first DES_HMAC sub-engine into the second FIFO, it directly enters the fourth FIFO without waiting and is then transferred to the CPU; meanwhile, a second packet from the internet enters the first DES_HMAC sub-engine for the first decryption/authentication process through the first FIFO;

(3) two operations are simultaneously performed if the control signal is two-sub-engine mode: the first packet directly enters the second DES_HMAC sub-engine for the second decryption/authentication process through the second FIFO without waiting meanwhile, the second packet enters the first the first DES_HMAC sub-engine for the first decryption/authentication process through the first FIFO;

(4) three operations are simultaneously performed if the control signal is two-sub-engine mode: while the first packet is outputted from the second DES_HMAC sub-engine into the third FIFO, it directly enters the fourth FIFO without passing the third DES_HMAC sub-engine and is then transferred to the CPU; while the first decryption/authentication process has been finished, the second packet enters the second DES_HMAC sub-engine for the second decryption/authentication process through the second FIFO without waiting; meanwhile, a third packet from the internet enters the first DES_HMAC sub-engine for the first decryption/authentication process through the first FIFO;

(5) Proceeds until all packets have been processed.

### BRIEF DESCRIPTION OF THE DRAWINGS

FIG. 1 is a block diagram of an IPSEC processor structure in prior art.

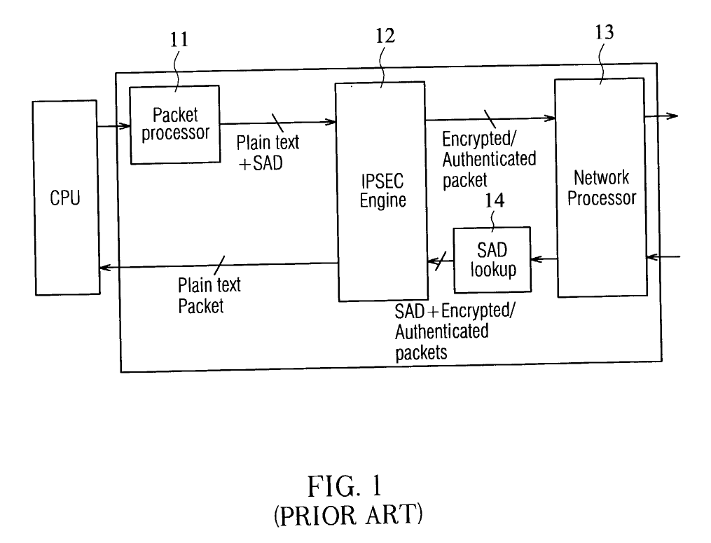

FIG. 2A is a schematic diagram shown a tunnel+tunnel mode in network environment; FIG. 2B is a block diagram of a transmitting flow in ESP tunnel+ESP tunnel mode of prior art; FIG. 2C is a block diagram of a receiving flow in ESP AH adjacency mode of prior art.

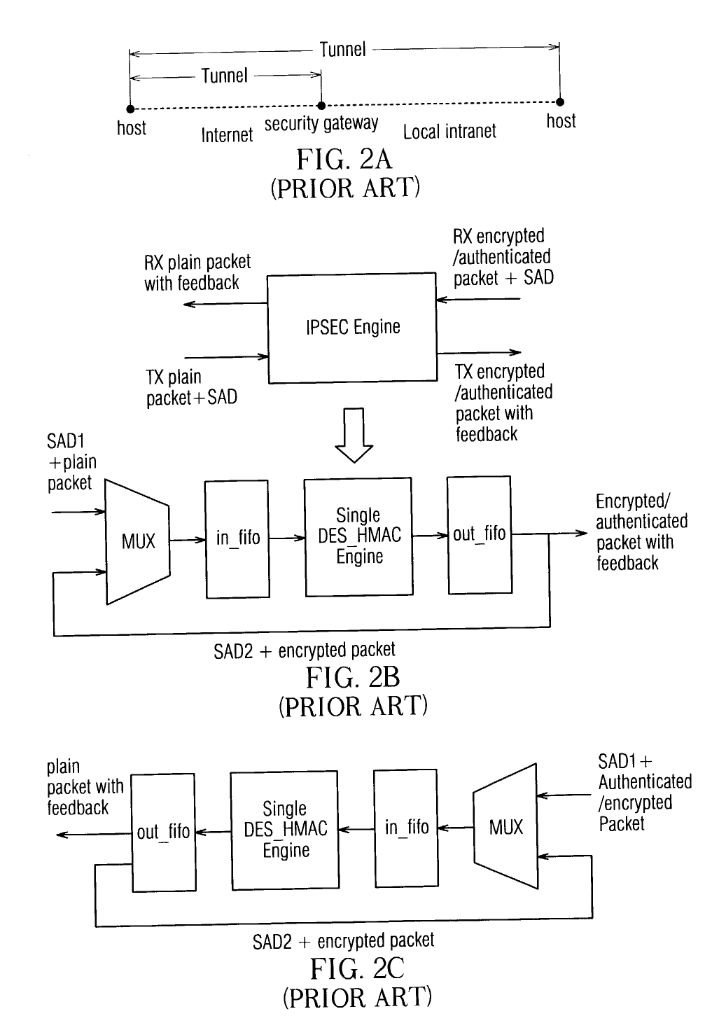

FIG. 3A is a block diagram of an architecture of a transmitting flow in an IPSEC engine; FIG. 3B is a block diagram of an architecture of a receiving flow in an IPSEC engine.

FIG. 4A is a schematic diagram shown a tunnel+tunnel mode in network environment; FIG. 4B is a schematic diagram of a packet format.

FIG. 5 is a schematic diagram of a packet descriptor format.

FIG. 6A is a schematic diagram of the cycle times in prior art; FIG. 6B is a schematic diagram of the cycle times in the invention.

### DESCRIPTION OF THE PREFERRED EMBODIMENTS

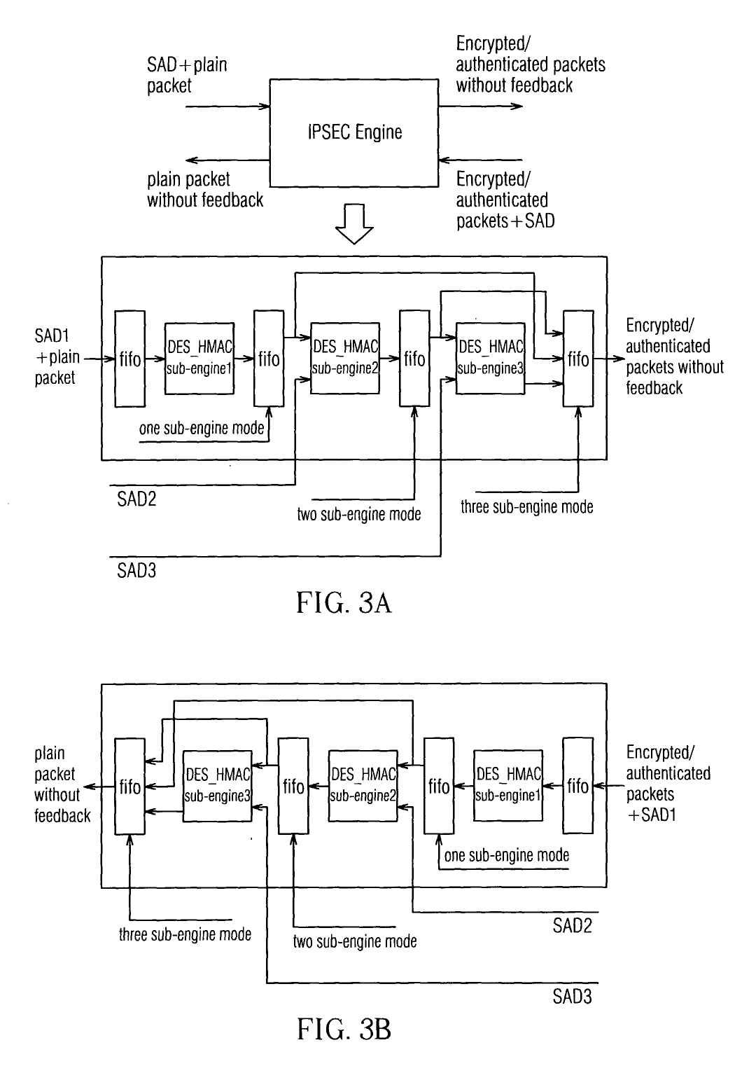

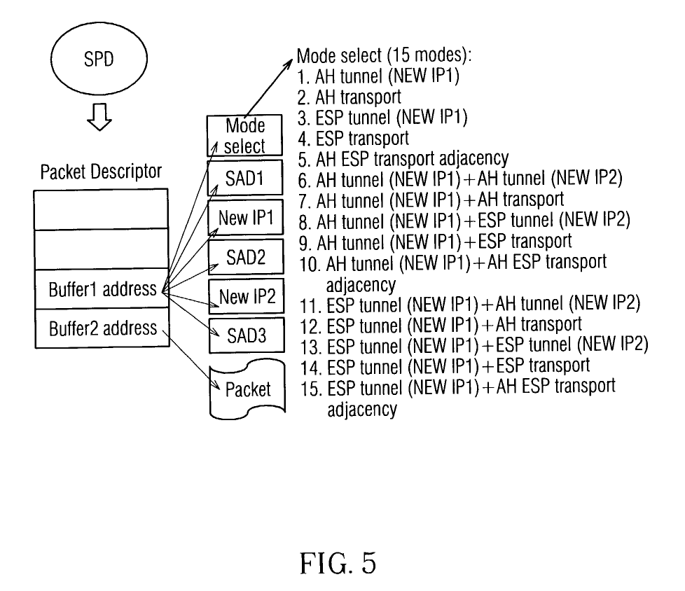

The invention provides a device for improving the efficiency and speed of dealing with the encryption and authentication process by using the pipelined architecture. In order to handle all the modes defined in RFC2401, 3 DES-HMAC sub-engines are built in the IPSEC engine as shown in FIGS. 3A and 3B. Each DES-HMAC sub-engine includes one DES engine and one HMAC engine. The function of the sub-engine depends on the SAD as seen in FIG. 5.

When a host determines to transmit the data with the IPSEC, the software looks up in the SPD (Security Policy Database), and the SAD (Security Association Database) table to determine the matched SAD for data transmission, and then the Security Association (SA) is set. In this new architecture, each DES-HMAC sub-engine is configured with the correspondingly matched SAD before packets are transmitted. According to the built SA, we know the number of the DES_HMAC sub-engine that the SA needs and then the number is used as a control signal.

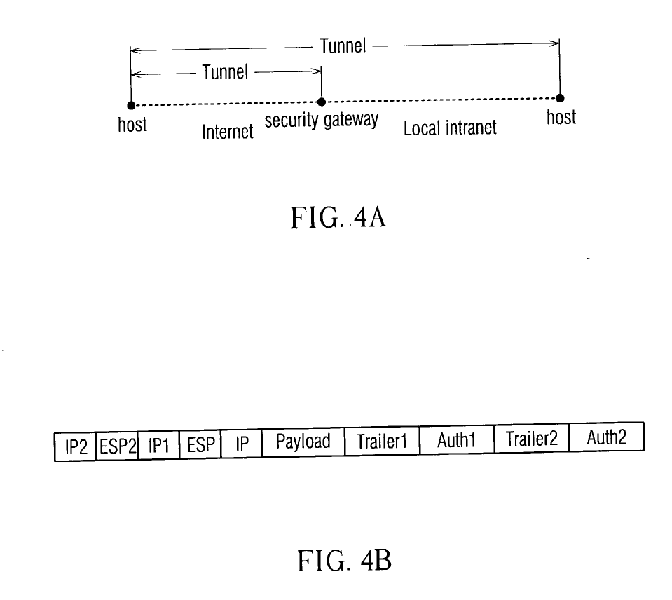

As illustrated in FIGS. 4A and 4B, for example, in the ESP tunnel+ESP tunnel mode, the software follows the lookup procedure to determine the SAD1 and the SAD2. The IPSEC processor configures the DES_HMAC sub-engine1 and the DES_HMAC sub-engine2 simultaneously with the data from the packet descriptor of FIG. 5. As the configuration step is done, the upper layer begins transmitting the data.

Before entering the engine, the packets are partitioned in the packet processor and the related information in the SAD is updated.

The IP2 and the ESP2 are bypassed to the in_fifo of the DES_HMAC sub-engine2, and IP1, ESP, IP, payload, trailer1 and auth1 of FIG. 4B are sent to the DES_HMAC sub-engine1. As soon as the first ciphered block of the packet comes out from the DES_HMAC sub-engine1, the in_fifo of the DES_HMAC sub-engine2 has enough data (64-bit for encryption or 512-bit for authentication) for the second ESP or AH process; therefore , the data in the in_fifo is moved into the DES_HMAC sub-engine2 for the next ESP or AH process right away. After finishing this process in the DES_HMAC sub-engine2, the output is transferred into the fifo and ready for the transmission to the internet. Also, the AH ESP Adjacency mode in RX status has the similar procedure.

By utilizing the pipelined architecture for the combination of multiple modes, it does not take any waiting time in the encryption and authentication process. A data block is immediately sent to the next DES_HMAC sub-engine for the next encryption and authentication process while the previous DES_HMAC sub-engine outputs the data block. The data blocks are sequentially transmitted without waiting even though the SA is changed. Finally, the output of the last DES-HMAC sub-engine is directly supplied to the next device. Therefore, it saves the waiting time that is wasted in the current technology and speed up the encryption and authentication process.

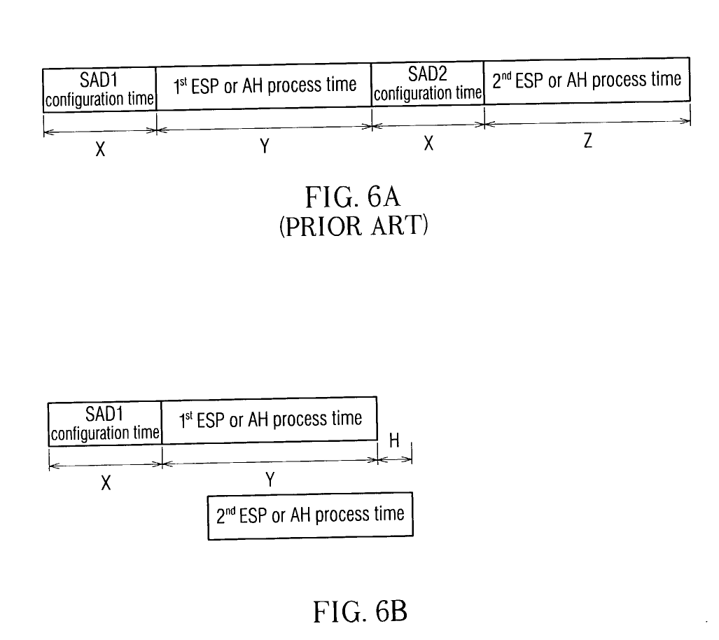

Assume that the engine configuration time is X cycles, the first ESP or AH process time and the second ESP or AH process time are Y cycles and Z cycles, respectively. When pipelined engine is utilized, the time from a whole packet's completing the first ESP or AH process to a whole packet's completing the second ESP or AH process is H cycles. As shown in FIG. 6A, the total time that one packet finishes the IPSEC process (encryption or authentication) in conventional architecture is 2X+Y+Z cycles. As to the invention, the process time is X+Y+H, and H<<Z. The invention almost can save X+Z cycles as seen in FIG. 6B, and does improve the performance significantly.

One of ordinary skill in the art appreciates that various modifications and changes can be made without departing from the scope of the present invention as set forth in the claims below. Accordingly, the specification and figures are to be regarded in an illustrative sense rather than a restrictive sense, and all such modifications are to be included within the scope of the present invention. Therefore, it is intended that this invention encompasses all of the variations and modifications as falling within the scope of the appended claims.

What is claimed is:

1. A pipelined engine for encryption/authentication in IPSEC (IP Security/RFC 2401), set as the transmit (TX) mode, comprising a first first_in_first_out (FIFO), a first data encryption standard_hashing for message code (DES_HMAC) sub-engine, a second FIFO, a second DES_HMAC sub-engine, a third FIFO, a third DES_HMAC sub-engine, a fourth FIFO and a control line,
when a host is going to transfer the data with the IPSEC, the control line being connected to the second FIFO, the third FIFO and the fourth FIFO, respectively, the software looking up in a security policy database (SPD) and a security association database (SAD) table to determine the matched SAD for data transmission according to the data of the packet descriptor, and then the Security Association (SA) set, the first DES_HMAC sub-engine, the second DES_HMAC sub-engine and the third DES_HMAC sub-engine simultaneously configured with the correspondingly matched SAD before packets transmitted, the software knowing the number of the DES_HMAC sub-engine that the SA needs according to the built SA and then using the number as a control signal, the control signal controlling the data flow direction through the control line, wherein the packet processing comprises the steps of:
(1) when the configuration is done and the upper layer starts to transmit a first packet, the first packet being divided into multiple blocks in a packet processor and then a first block entering the first DES_HMAC sub-engine for the first encryption/authentication process through the first FIFO;
(2) two operations simultaneously being performed if the control signal is one-sub-engine mode: while the first block of the packet is outputted from the first DES_HMAC sub-engine into the second FIFO, it directly entering the fourth FIFO without passing the second DES_HMAC sub-engine and then transferred to the internet; meanwhile, a second block of the packet entering the first DES_HMAC sub-engine for the first encryption/authentication process through the first FIFO;
(3) two operations simultaneously being performed if the control signal is not one-sub-engine mode: the first block of the packet directly entering the second DES_HMAC sub-engine for the second encryption/authentication process through the second FIFO without waiting; meanwhile, a second block of the packet entering the first DES_HMAC sub-engine for the first encryption/authentication process through the first FIFO;
(4) three operations simultaneously being performed if the control signal is two-sub-engine mode: while the first block of the packet is outputted from the second DES_HMAC sub-engine into the third FIFO, it directly entering the fourth FIFO without passing the third DES_HMAC sub-engine and then transferred to the internet; while the first encryption/authentication process has been finished, the second block of the packet entering the second DES_HMAC sub-engine for the second encryption/authentication process through the second FIFO without waiting; meanwhile, a third block of the packet entering the first DES_HMAC sub-engine for the first encryption/authentication process through the first FIFO;
(5) three operations simultaneously being performed if the control signal is three-sub-engine mode: the first block of the packet directly entering the third DES_HMAC sub-engine for the third encryption/authentication process through the third FIFO without waiting; while the first encryption/authentication process has been finished, the second block of the packet entering the second DES_HMAC sub-engine for the second encryption/authentication process through the second FIFO without waiting; meanwhile, a third block of the packet entering the first the first DES_HMAC sub-engine for the first encryption/authentication process through the first FIFO;
(6) four operations simultaneously being proceeded if the control signal is three-sub-engine mode: while the first block of the packet is outputted from the third DES_HMAC sub-engine to the fourth FIFO, it is ready to be transferred to the internet; while the second encryption/authentication process has been finished, the second block of the packet entering the third DES_HMAC sub-engine for the third encryption/authentication process through the third FIFO without waiting; while the first encryption/authentication process has been finished, the third block of the packet entering the second DES_HMAC sub-engine for the second encryption/authentication process through the second FIFO without waiting; meanwhile, a fourth block of the packet entering the first DES_HMAC sub-engine for the first encryption/authentication process through the first FIFO;
(7) proceeding until all packets having been processed.

2. A pipelined engine for the decryption/authentication in IPSEC, set as the receive (RX) mode, comprising a first FIFO, a first DES_HMAC sub-engine, a second FIFO, a second DES_HMAC sub-engine, a third FIFO, a third DES_HMAC sub-engine, a fourth FIFO and a control line,
when a host is going to transfer the data with the IPSEC, the control line being connected to the second FIFO, the third FIFO and the fourth FIFO, respectively, the software looking up in a SPD and a SAD table to determine the matched SAD for data reception according to the packet data, and then SA set, the first DES_HMAC sub-engine and the second DES_HMAC sub-engine simultaneously being configured with the correspondingly matched SAD before packets are received, the software knowing the number of the DES_HMAC sub-engine that the SA needs according to the built SA and then using the number as a control signal, the control signal controlling the data flow direction through the control line, wherein the packet processing comprises the steps of:
(1) after the configuration is done, a first packet being received from an internet and then entering the first DES_HMAC sub-engine for the first decryption/authentication process through the first FIFO;
(2) two operations simultaneously being performed if the control signal is one-sub-engine mode: while the first packet is outputted from the first DES_HMAC sub-engine into the second FIFO, it directly entering the fourth FIFO without waiting and then transferred to the CPU; meanwhile, a second packet from the internet entering the first DES_HMAC sub-engine for the first decryption/authentication process through the first FIFO;
(3) two operations simultaneously being performed if the control signal is two-sub-engine mode: the first packet directly entering the second DES_HMAC sub-engine for the second decryption/authentication process through the second FIFO without waiting; meanwhile, the second packet entering the first the first DES_HMAC sub-engine for the first decryption/authentication process through the first FIFO;
(4) three operations simultaneously being performed if the control signal is two-sub-engine mode: while the first packet outputted from the second DES_HMAC sub-engine into the third FIFO, it directly entering the fourth FIFO without passing the third DES_HMAC sub-engine and then transferred to the CPU; while the first decryption/authentication process has been finished, the second packet entering the second DES_HMAC sub-engine for the second decryption/authentication process through the second FIFO without waiting; meanwhile, a third packet from the internet entering the first DES_HMAC sub-engine for the first decryption/authentication process through the first FIFO;
(5) proceeding until all packets having been processed.
